(19) United States
(12) Patent Application Publication
(10) Pub. No.: US 2007/0238079 A1
(43) Pub. Date: Oct. 11, 2007

(54) Strategic enforcement of long-term memory

(75) Inventor: Benjamin D. Harrison, Provo, UT (US)

Correspondence Address: BANNER & WITCOFF, LTD., 1100 13th STREET, N.W., SUITE 1200, WASHINGTON, DC, 20005-4051, US

(73) Assignee: Big Brainz, Inc., Provo, UT (US)

(21) Appl. No.: 11/398,811

(22) Filed: Apr. 6, 2006

(51) Int. Cl. G09B 19/00

(52) U.S. Cl. 434/236

(57) ABSTRACT

Methods are disclosed for instructing a player in a video game in a more effective manner. In an embodiment, a first fact is provided to a player and then the player is asked questions about the first fact, solidly placing the first fact in the player's short-term memory. Then a player is provided a second fact, interrupting the short-term memory of the first fact. The player is then asked a question about the first fact, interrupting the short-term memory of the second fact. A question is then asked about the second fact, interrupting the player's short-term memory of the first fact. Additional facts may be similarly handled. By the use of the strategic interruptions, the facts are pushed into the player's long-term memory deeper and more quickly than with the use of pure repetition of facts while they are in the player's short-term memory. The questions may be incorporated into virtual entities that the player is required to interact with. To improve gameplay, the player's input may be automatically processed once the player enters the expected number of digits associated with the expected answer.

### BACKGROUND OF THE INVENTION

1. Field of the Invention

The present invention relates to the field of education methods, and more particularly to the field of teaching facts through the use of computerized methods of stimulating a student's long-term memory.

2. Description of Related Art

Video games have rapidly eclipsed conventional games such as board games as the medium of choice for entertainment. Research and development have allowed an ever increasing array of sophisticated graphics and artificial intelligence, thus greatly improving the immersive qualities of video games and helping to make them more entertaining. As a result, video game sales have greatly expanded and have begun to eclipse the traditional motion picture industry in terms of sales, thus indicating that video games are a powerful, attractive and valuable medium for providing entertainment.

Unfortunately, the use of educational software such as educational video games has been less successful. While a large amount of educational software has been developed that has been directed toward teaching a large array of subjects ranging from math and reading to aviation and warfare, the overall sales of educational software, particularly fun education software such as educational video games, has dropped despite the fact that entertainment focused video game sales have dramatically increased. The educational software industry has plummeted from over $1 billion in annual sales in 1995 to less than $150 million in 2004. One substantial reason for this decrease has been the failure to create educational software that is as educational as human instructors or as entertaining as purely entertainment-oriented video games.

A second significant challenge faced by the educational software industry is that educational software such as education video games are typically forced to balance entertainment with educational value, meaning that to the degree a game becomes entertaining it needs to become less educational—and vice-versa. This balancing is typically necessary because it's difficult to blend the education directly into the gameplay itself, so games can basically only do one or the other at any given time—i.e., either educate or entertain—thus the need to balance the gameplay between entertainment and education. In part this is because while entertainment-focused gameplay has had many years of well-funded research, the development of education-oriented games has received relatively little development, as evidenced by the astonishing decline in revenue for education based software while entertainment-oriented video game revenue has skyrocketed.

### BRIEF SUMMARY OF THE INVENTION

The following represents a simplified summary of some embodiments of the invention in order to provide a basic understanding of various aspects of the invention. This summary is not an extensive overview of the invention nor is it intended to identify key or critical elements of the invention or to delineate the scope of the invention. Its sole purpose is to present some embodiments of the invention in simplified form as a prelude to the more detailed description that is presented thereafter.

A group of facts that are intended to be taught may be divided into sets of facts and each set may be divided into subsets of facts. Players may be taught facts from a first subset of facts. After teaching at least two facts from the first subset of facts, questions regarding the two facts are asked so as to strategically interrupt the player's short-term memory regarding each fact, thus causing each fact to be pushed deeper in to the player's long term memory. In an embodiment, the questions may be incorporated into virtual entities that the player may interact with in an engaging manner. The player's input may involve typing in an answer to a question where the input is automatically processed when the player enters the expected number of characters. In an embodiment, the facts being used to question the player may be taught through an interaction that involves the graphic depictions of the facts transforming into virtual entities that the player may then interact with.

### BRIEF DESCRIPTION OF THE DRAWINGS

The present invention is illustrated by way of example and not limited in the accompanying figures in which like reference numerals indicate similar elements and in which:

FIG. 1 illustrates a schematic representation of a dataset of facts.

FIG. 2 illustrates a schematic representation of a dataset of facts divided into milestones or sets of facts.

FIG. 3 illustrates a schematic representation of a milestone divided into baskets or subsets of facts.

FIG. 4 illustrates an embodiment of a method of controlling a player's progression through a portion of a video game.

FIG. 5 illustrates an embodiment of a method of controlling the player's interaction with mini-bosses.

FIG. 6 illustrates an embodiment of a method of controlling the player's interaction with basket bosses.

FIG. 7 illustrates an embodiment of a method of controlling the player's interaction with final bosses.

FIG. 8 illustrates an embodiment of a player's avatar interaction with a virtual entity.

FIG. 9 illustrates an alternative embodiment of a player's avatar interaction with a virtual entity.

FIG. 10 illustrates an embodiment of a graphical depiction of transmogrification that may be used in accordance with one or more aspects of the present invention.

FIG. 11 illustrates an embodiment of a computer system that may be utilized in accordance with one or more aspects of the present invention.

### DETAILED DESCRIPTION OF THE INVENTION

As can be appreciated from the above discussion, a genuine combination of education and entertainment could allow a game to be as entertaining as pure-entertainment games and as educational as pure-instructional games. Indeed, because of the synergies involved, a well designed educational video game could be more entertaining and more education than either pure form of video game. This is because effective, genuine education is engaging and entertaining in and of itself, while top-notch entertainment will keep the player much more motivated to learn.

It should be noted that game genres may vary and each genre typically will require a different graphical implementation in order to be successful. Common video game genres include first person shooters games (which may or may not actually involve shooting and which are known as FPS), action games, strategy games, role playing games (known as RPG), and fighting games. Of course, these genres may also be somewhat combined together but in general FPS games typically include some sort of graphical depiction of a monster that needs to be defeated and the view point is from or close to a first person view point. In addition, the player is typically progressing through a simulated environment that may require the player to move, jump and otherwise interact with the virtual environment so as to avoid falling off an elevated portion of the simulated virtual environment. It should be noted that other genres often include similar aspects, thus the definition between FPS games and action or adventure games has begun to blur. One fairly common difference, however, is that while the player's avatar may be partially visible in a FPS, the viewpoint is typically constrained to the direction the avatar is facing. Other genres typically use a third person view so that the entire avatar is visible and the camera angle is adjustable. The collective view point and graphical interface for the video game will be referred to as the video game interface. As the use of a video game interface is known, as illustrated by the number of video games in existence, no further discussion need be provided regarding the general concepts involved in creating video game interfaces. However, aspects of the present invention are considered broadly applicable to the various video game interfaces.

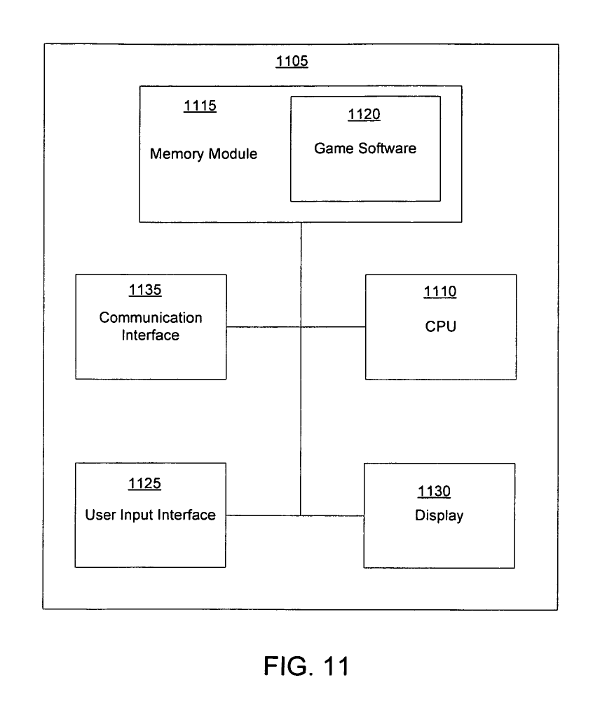

The present invention is intended to be implemented on a computer system or other data processing system. A simplified schematic of a computer system 1105 is disclosed in FIG. 11. The computer system 1105 includes a processor 1110, a memory module 1115 that includes game software 1120, a user interface 1125, a display 1130, and an optional communication interface 1135. It should be noted that the depicted connections between the various components is intended to represent logical connections and is not intended to limit the scope of the computer system that may be used. As is known, the computer system 1105 may be in a single housing such as typically used for hand-held video games, may be a clam-shell device similar to certain phones or laptops, may be similar in function to a PDA or small tablet PCs or it may comprise of two or more separate housings as is common for certain desktop computers, laptop computers, game consoles, etc.

As is known, the processor 1110 may be controlled by operating system software that also resides in the memory module 1115. It should be noted that the memory module 1115 may comprise any known type of memory, including but not limited to, volatile RAM, non-volatile RAM, ROM, flash memory and may be local or remote or both remotely and locally located. If at least a portion of the memory module 1115 is located remotely, the communication interface 1135 may be used to operatively connect the remote portions of the memory module 1115 to the other components of the computer system 1105. This communication may be conducted in a wired or wireless manner and may be accomplished by any known method, including but not limited to, standards such as Ethernet. As can be further appreciated, portions of the software and processor operation may be accomplished via a WAN such as the Internet through web applications such as AJAX. Indeed, as network capabilities improve, it may make more sense to serve video games over such a network than to provide physical copies to each individual, although either method or even a combination of the two methods may be used in accordance with the current invention.

The user interface 1125 is configured to aid the player in inputting information into the computing system 1105. An embodiment of the user interface 1125 may be a combination of a keyboard and mouse. An alternative embodiment of the user interface 1125 may be a stylus in combination with a touch sensitive screen. Another alternative embodiment of the user interface 1125 may be a microphone in communication with a speech recognition engine (which may be software or firmware or an amalgam of programming and hardware). Yet another alternative embodiment may include a camera configured to sense gestures by the user. As can be appreciated, numerous other variations of user interface 1125 are also possible, including known game controller designs and the like.

While computer systems and video game interfaces are generally known and used with educational video games, several mechanisms may be used to optimize the education and entertainment experience of the player. One mechanism is to accelerate recall development. Another mechanism is to better integrate education concepts and instructions into the gameplay. These and other mechanisms may be used in a synergistic manner as discussed below.

It should be noted that an aspect of learning requires the student to transfer facts into long term memory so that answers based on those facts can be provided in response to questions. Indeed, at a basic level, all learning can be approximated as the process of taking facts and placing them into long term memory so that they may be recalled in response to questions. Looking first at the mechanism of accelerating recall development, an embodiment allows for faster memorization with less frustration than past methods that simply implemented various methods of random or ordered repetition. Thus, accelerating recall development can help improve the rate of converting information into the players' long-term memory.

For example, to learn multiplication tables, traditional methods have involved repeating facts such as “1×2=2” over and over, the goal being to move the fact from the student's short-term memory into the student's long-term memory. One method of doing this has been to simply provide random drilling as is typically used by educational games. This method is capable of ultimately achieving the goal as sheer repetition will eventually cause information to be placed into the player's long-term memory. However, such repetition can be frustrating and tedious and is not the most effective mechanism for transferring facts into long term memory. Furthermore, if students are asked questions to which they cannot recall the answer as a result of an excessive delay, additional frustration will result.

Therefore, an embodiment improves the transfer of facts from short-term memory to long-term memory by strategically interrupting a player's short-term memory with other facts being learned simultaneously.

To illustrate, repeating the fact “6×9=54” over and over focuses on the player's short-term memory and does little to develop their long-term memory of the fact. However, too long a delay between asking the question of what does “6×9” equal lets the answer fade completely from the player's short-term memory, forcing them to start over with the answer in short-term memory. Therefore, in an embodiment a player is asked a question about the fact “6×9=54” and then is asked a question about a different fact. A following question may then be regarding the fact “6×9=54.” The interruption tends to force the player to use longer term memory to recall the answer without requiring complete recall. As the player becomes more familiar with the answer, the time between similar questions can be increased in a strategic manner without unduly frustrating the player. Determining the ideal amounts of interruption and delay require testing specific to each type of information and target audience. Therefore, it is the method of use of strategic interruptions that forms the focus of accelerating recall development discussed herein.

Turning to the second mechanism, better integration of education into the gameplay itself can allow for a more effective, engaging experience. These features include: 1) embodying educational questions directly into virtual characters that the player can battle directly with by inputting correct answers (mental ammunition); 2) transforming of educational concepts into representative, interactive entities that can then be manipulated in educationally meaningful ways, and 3) enabling players to input answers into the game without having to hit a concluding input command.

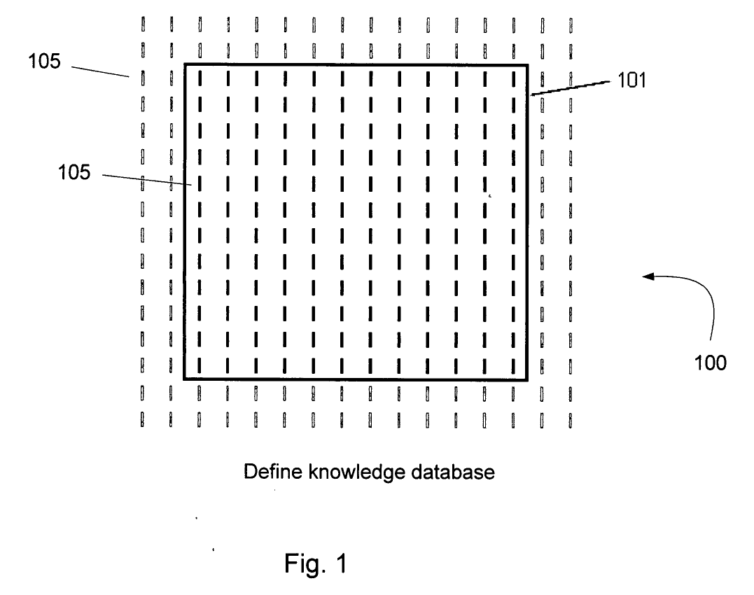

It should be noted that in a preferred embodiment, both mechanisms may be incorporated so as to maximize the entertainment and educational experience. However, in alternative embodiments one or the other may be used as is appropriate for the type of video game and the subject matter being taught. To further explain these mechanisms, FIGS. 1-3 illustrate several useful concepts.

Looking at FIG. 1, a universe of knowledge 100 is made of facts 105 and a dataset 101 (which may be structured as a database) may be defined as the facts 105 that are to be learned from the video game. For instance, if teaching mathematics one might choose multiplication facts “1×1” through “12×12” to be included in the dataset 101. If teaching foreign language, one might compile a list of all the vocabulary words to be taught and these words could be included in the dataset 101. It should be noted that the video game may include a larger dataset 101 and adjust the facts 105 to be taught depending on the education level and attitude of the player. As can be appreciated, this can allow for a single video game to be used by a wider range of students, thus increasing the video game's market appeal while reducing its development costs.

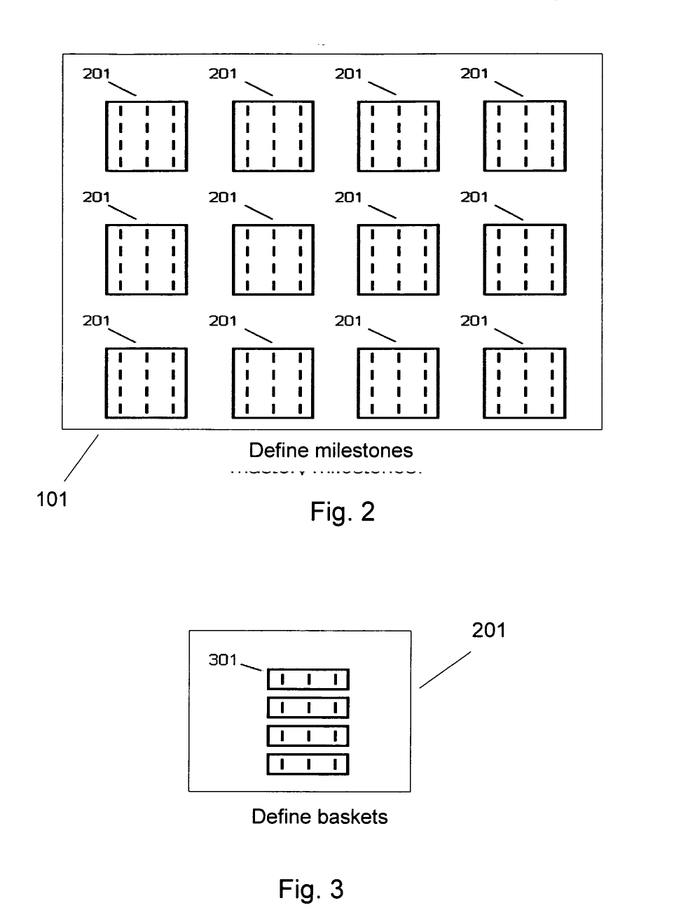

Next, as illustrated by FIG. 2, the dataset 101 is divided into milestones 201. The milestones 201 should preferably be large enough so that it will require long-term memory to answer all the facts in that group, but small enough to keep players motivated enough to complete them. For instance, when teaching multiplication to children, groups of 12 facts (such as “6×1” through “6×12”) have been found to work well, while medical students might find 50 to 100 vocabulary words per group manageable.

Then, as illustrated in FIG. 3, the milestones 201 are divided into baskets 301. In an embodiment the baskets may include three or more facts. As can be appreciated below, having three or more facts tends to make the next question less obvious to the player. However, overly large baskets require the player to more quickly put the facts into long-term memory and therefore may be more challenging than is desired.

Once the dataset of facts is divided into milestones and baskets (e.g., sets and subsets of facts), as discussed above, the previously discussed education mechanisms may be used to help the player more rapidly transfer the facts into long term memory while enjoying the education process. It should be noted the facts may be further divided (e.g., the subsets may have sub-subsets) if the information is suited to further compartmentalization. If so further divided, the mini-boss approach as discussed below may be used with the lowest set level. It should be noted that as used herein, a set may consist of one or more items unless otherwise noted.

In an embodiment, developing memory recall may involve combating multiple classes of intelligent virtual entities, or bosses. A boss may be provided in a range of shapes and sizes and difficulties and often initial bosses are smaller and less difficult to overcome than later bosses so as to give the player a sense of accomplishment when the later bosses are defeated. For example, mini-bosses, basket bosses and final bosses may be used for a total of three types of bosses. It should be noted that some different number of boss types could be used. As is known, bosses are virtual entities that players face in the simulated virtual environment.

To provide a combination of entertainment and education, a gaming environment can be set up that requires each boss be faced and/or defeated in order for a player to move on. In an embodiment, this can be accomplished be setting up a series of locked doors, where the player must obtain a key from a boss in order to unlock the next door. Multiple bosses may guard a single key and a single boss may guard multiple keys. In an alternative embodiment, physical barriers, such as electric fences or wide chasms can be used so as to physically keep the player from progressing through a level. In an embodiment the fences may be defused by completing comprehension segments and the chasms may be crossed as the player defeats intelligent elevators and lifts.

Before a player faces a mini-boss, it is helpful to ensure that the player has comprehended the facts needed to answers questions posed by the mini-boss. Therefore, before facing a first mini-boss, the player learns a first fact. This can take place in a comprehension segment or level of the game. In an embodiment, the comprehension segment may be improved by using concept transmogrification, as will be discussed in greater detail below. Preferably, by the time the player finishes the comprehension segment of the game the needed fact or facts will be stored in the player's short-term memory.

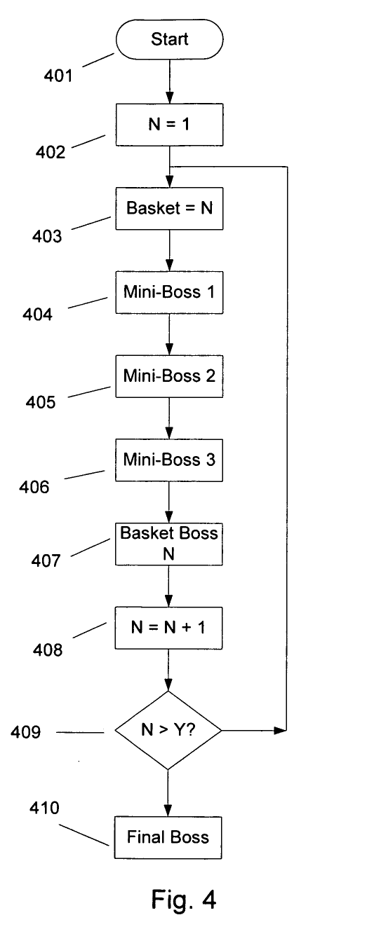

Looking at FIG. 4, an embodiment of how the player can progress through a milestone 201 is depicted. In step 401, the player starts a level associated with a milestone. In step 402, N is set equal to 1 and then basket N is selected in step 403. In step 404, the player encounters a first mini-boss, which will begin pushing a first fact, which may have just been learned in a comprehension segment, from the player's short-term memory to the player's long-term memory. As the player has only learned a single fact, such as “6×9=54,” the first mini-boss will be limited in its effectiveness because any question the mini-boss asks is limited to the one fact, which is already in short-term memory. Thus, the first mini-boss may simply ask several questions related to the first fact.

In an embodiment, each question asked by this first mini-boss may be the same, “6×9=______”. However, as the fact “6×9=54” has three parts, different questions about the same fact can be asked such as “6______=54” or “______×9=54” or “6×9=______” so as to provide some variety. When the player has correctly answered all the first mini-boss questions consecutively, the first mini-boss will be defeated, and the next section will be unlocked. It should be noted that this type of short-term memory drilling is not as effective as the methods that become possible once the player knows more than one fact.

Next in step 405 a player faces a second mini-boss. Before facing the second mini-boss, the player learns a second fact from the first basket. In an embodiment, the learning of the second fact occurs after player faces the first mini-boss but before the player faces the second mini-boss. As can be appreciated, it is preferable that the time between facing the first mini-boss and the second mini-boss is not so great as to cause the player to forget the first fact.

While facing the second mini-boss, the player can be asked questions about the first fact and the second fact. As the player has just learned the second fact, the second fact will be fresh in the player's short term memory. Therefore, the first question the second mini-boss asks should be about the first fact. The first fact was likely not impressed deeply enough into the player's long-term memory at this point to remain permanently stored, but it typically will still be there. By forcing the player to recall this faint memory from long-term memory, we clarify it and etch it more solidly into long-term memory in a manner that is more effective than just repeating it over and over in short-term memory as pure repetition of the first fact provided.

In addition, forcing the player to stop and recall the first fact effectively clears the player's short-term memory of the second fact. Therefore, the next question should be directed toward the second fact so as to force the player to recall the second fact from, to a greater degree, the player's long-term memory. Again, forcing the player to pull the answer from as deep in the player's long-term memory as possible accelerates the knowledge's entrenchment into the player's long-term memory.

Upon answering the questions of the second mini-boss correctly, thus defeating the second mini-boss, the player moves on to the comprehension phase of a third fact and then encounters a third mini-boss in step 406. The third mini-boss can interrupt the player's short-term memory with questions about the first and second fact before asking a question about the third fact. Thus the third mini-boss forces the player to pull the facts from deeper in the player's long-term memory, thus helping to etch the facts more completely into the player's long-term memory. It should be noted that depending on the player's comprehension abilities and the information being presented, the number of questions that a mini-boss may ask about each fact can vary.

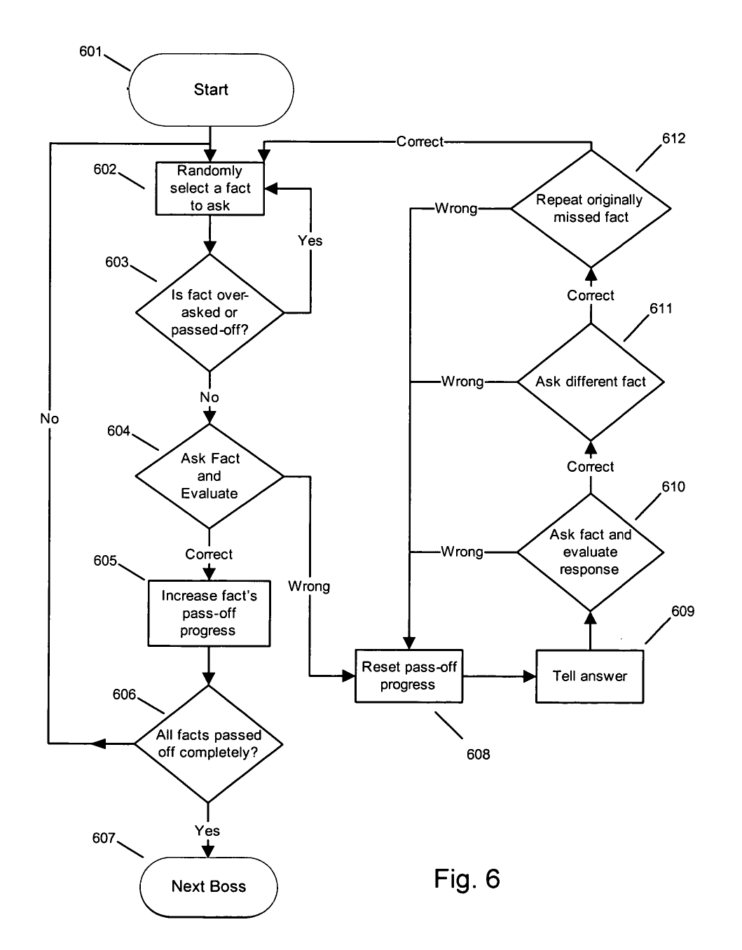

Next in step 407 a basket boss is encountered. The basket-boss can ask questions about all the facts in the basket (or subset) in a strategic manner, as will be discussed below. After the player has correctly answered questions associated with each of the facts according to predetermined criterion, such as discussed below with respect to FIG. 6, N is incremented in step 408. Next in step 409, a check is made to see if N is greater than Y, where Y is the number of baskets. If N is not greater than Y, the process continues at step 403 with the next basket. However, if N is greater than Y, then all the basket bosses have been defeated and the player is now ready for the final boss in step 410. The final boss asks questions from all the baskets and preferably will ask questions addressing all the facts.

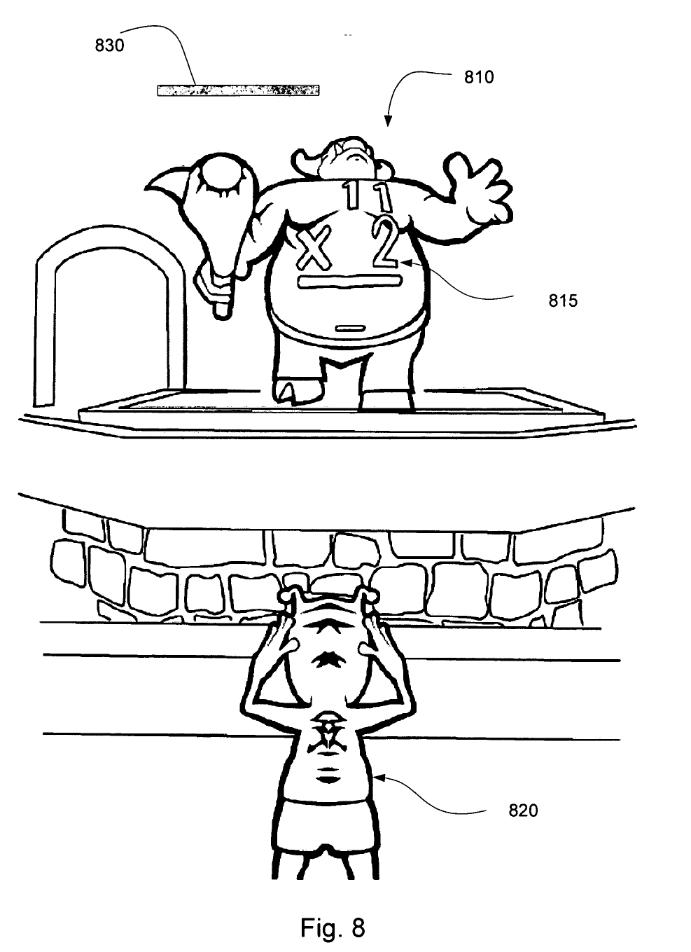

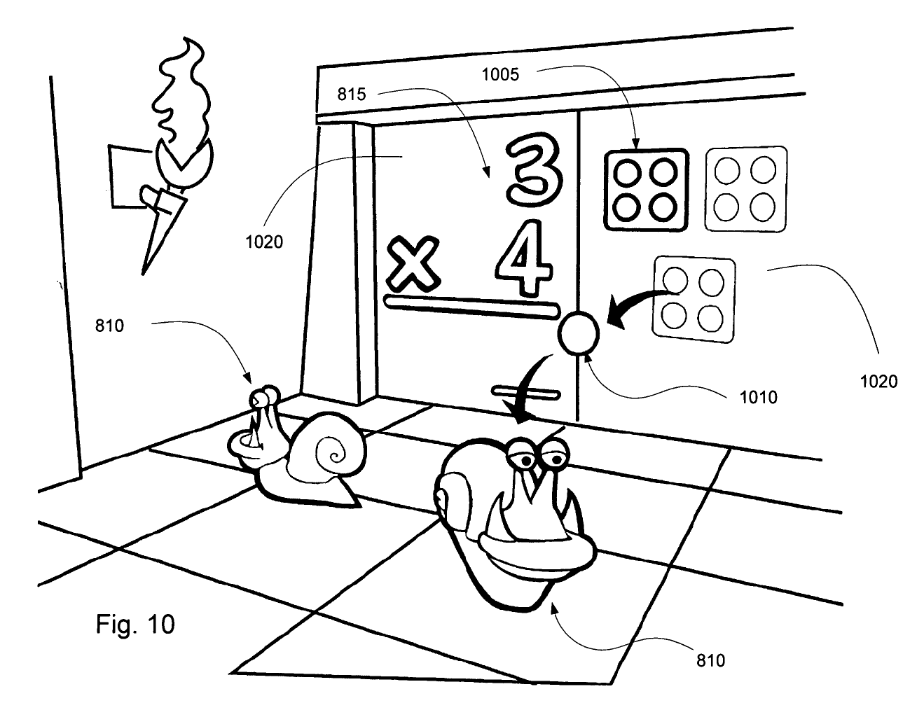

An embodiment of how a video game may progress can be further explained with reference to FIGS. 8 and 10. A player may control an avatar 820 through a simulated virtual environment that includes various physical obstacles that must be crossed or otherwise navigated. The avatar may include the ability to move forward, turn to the left or right, and jump, to name a few of the possible controls. After traveling through the virtual environment, which may include traversing chasms and traveling through tunnels and the like, the player may encounter a comprehension room such as is illustrated by FIG. 10. As depicted, the comprehension room includes graphical depictions 1005 of a concept that are positioned on doors 1020. An associated question 815 may also be depicted on the doors 1020. In FIG. 10, the graphical depictions are cards with dots, however other graphical depictions may be used as is appropriate for the concept being represented. The graphical depictions then transmogrify into virtual entities 810 that the player may interact with. In an embodiment, the player collects the virtual entities and then throws the virtual entities back at the doors 1020. In an embodiment, the collecting may build an answer to the concept. For example, if the concept is “3×4=12”, the player may collect a first virtual entity and be shown a 4, upon collecting a second virtual entity the player may be shown an 8 and upon collecting a third virtual entity be shown a 12, thus building the answer to what “3×4” equals. In the throwing process, the virtual entities may transmogrify back into the graphical depictions, allowing the player to build the answer to the question 815 that is also depicted on the door 1020 a second time.

Once the player has completed the comprehension room, the player may face a boss virtual entity 810, such as is depicted in FIG. 8. The player is given an amount of time to input an answer to a question that is incorporated into the virtual entity 810. If the answer is correct, another question may be displayed on the virtual entity. After the player inputs correct answers to a predetermined or responsive number of questions, the virtual entity will be defeated and the player may progress further through the simulated virtual environment. As additional facts are provided to the player, the boss virtual entities can ask questions in a manner so as to provide strategic interruptions in the player's short term memory, thus helping to enforce and more permanently etch the facts into the player's long-term memory. As can be appreciated, however, the concept disclosed is not limited to the depicted simulated environments.

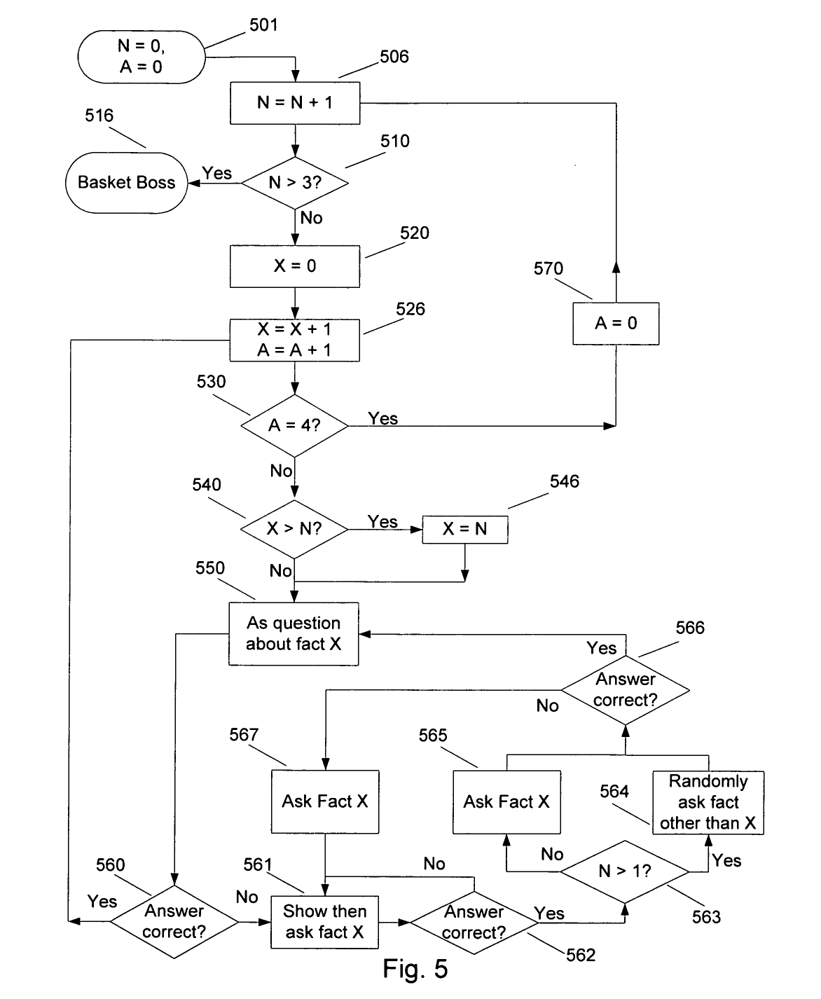

Turning to FIG. 5, a more detailed method is depicted to illustrate an embodiment of how the players may logically progress through the mini-bosses (steps 404 through step 406). First in step 501, N and A are set equal to zero, where N represents the mini-boss and A represents the number of questions that the current process has at least started. Next in step 506, N is incremented by 1. As N represents the mini-boss, when N is equal to 1, the player is facing the first mini-boss. Next in step 510, a check is made to see whether N is greater than 3, where 3 is the total number of mini-bosses in the basket 201. If N is greater than 3, the player has defeated (or at least faced) all three mini-bosses and the player proceeds to face a basket boss in step 516. However, if N is not greater than 3, then the player has not finished facing all the mini-bosses and proceeds to step 520.

In step 520, X is reset to zero since at this point the mini boss has not yet asked any questions. Next, because the mini-boss can begin by asking a question about the first fact, X is incremented in step 526 to one. Step 526 also increments A in order to track the total number of question that have been initiated. Next in step 530, a check is made to see whether A is equal to 4. As A equals the number of questions that a player has been asked, the mini-boss checks to see if it has already challenged the player with the determined number of questions and received an appropriate response, When this is the case A is reset to zero in step 570 and N is incremented in step 506. It should be noted that the value used to compare to A in step 530 could be set to some other value so as to require the player to answer some other number of questions.

If the mini boss determines in step 530 that it still has questions to ask then in step 540, a check is made to see if the mini boss is asking a question about the correct fact by determining whether X is greater than N. As X equals the current fact being asked and N equals the current mini-boss, if X is greater than N it represents a fact that the player has not yet encountered. Therefore in step 546, the mini-boss is limited to asking questions about facts to which the player has already been introduced. Once the correct fact has been determined, the player is asked a question regarding that fact in step 550.

Next in step 560 a check is made to see if the correct answer was given. If the player has inputted an incorrect answer, they are shown the correct answer and then asked for this response again in step 561. Step 561 is repeated until the player is determined to have entered the correct answer in step 562. Once the player has entered the correct answer from their short-term memory in this manner, the mini-boss determines whether there is another fact it can use to clear the player's short-term memory in step 563 (because when N is 1 there is only one fact). If there is another fact available to the mini-boss, it will randomly select one of the available facts and ask the player a related question in step 564. The ability to ask a different fact will clear the player's short-term memory and enable more efficient learning of the previously missed fact. However, if a different fact is not available, then the mini-boss will simply ask the missed fact again to try to push the information into the player's long-term memory as much as possible through normal repetition in step 565.

In step 566, regardless of which question is asked, if it is determined that the answer given is correct, the player is returned to the point in the mini-bosses questioning where they first gave an incorrect answer in step 550. After this process is through, the player has been given additional training that will help them defeat subsequent mini-boss questions (as well as the basket and final boss). It should be noted that if the mini-boss only has one fact to teach the player, this depicted process could result in an excessive amount of repetition and step 565 could reasonably skip directly back to step 550. However, if the mini-boss only has one fact and the player is still missing it, the extra repetition may be warranted. The mini-boss will also need to deal with an incorrect answer in step 566. In this case the mini boss will shift over to training the player on the fact associated with the latest incorrect answer in step 567, and loop back to step 561. It should be noted that while acceptable, there is no requirement that the same question be asked to reinforce a particular fact. Instead, as discussed above, different questions regarding the same fact may be asked as an alternative to repeatedly asking the same question about a particular fact.

If step 560 determines that the correct answer was given, then step 526 is repeated. After the player has correctly answered each question associated with the mini-boss, the value of A will be reset to zero in step 570 and the value of N will be incremented in step 506. If A's maximum value is set to some other value, such as 2 or 6, the player will answer one or five questions, respectively. The value of A may also be set differently for each mini-boss, which may be helpful if the number of mini-bosses is larger than three.

Applying the method of FIG. 5 to a configuration of three mini-bosses per basket boss, N would be initially be set to equal to 1, representing the first mini-boss. As there is initially only one fact and the method of FIG. 5 depicts the mini-boss asking three questions, the mini-boss would ask three questions in a row about the first fact and then the player would move to the next mini-boss (N equal to 2). As the second mini-boss can ask questions about two facts, and the second fact was just shown to the player, a question is first asked about the first fact and then a question is asked about the second fact. This process of alternating questions so as to strategically interrupt the player's short-term memory is continued until the player has answered the determined number of questions (three in the depicted FIG. 5) and then the player moves on to the third mini-boss (N equal to 3). As N equals 3, there are now 3 facts that the third mini-boss can ask and the third fact is the most recent fact shown to the player. Therefore the third mini-boss first asks a question about the first fact, then a question about the second fact and then a question about the third fact. Upon successfully answering these three questions, N is incremented again. However, as N is now greater than the number of mini-bosses in the basket, the player now faces a basket boss.

As can be readily appreciated from the above example, the number of mini-bosses can be changed. In addition, the number of questions that a player must answer correctly can also readily change. Further modifications are also possible. For example, facts from prior baskets may be integrated with the first two mini-bosses in a basket to allow strategic interruption and thereby limit plain drilling.

It should be noted that FIG. 5 is merely one embodiment of how to provide the strategic interruption of short-term memory so as to reinforce placement of the facts deeper into long-term memory. Thus, modifications can be used to simplify or increase the complexity of the algorithm used to guide the player through the mini-bosses. Delay periods where the player is forced to do some other task, such as navigate through a simulated virtual environment, may also be included to help ensure the player's short-term memory is cleared.

It should be noted that the check in step 560 may also include a time check. In such an embodiment, the failure of the player to answer within a predetermined period, such as but not limited to, four seconds will act as an incorrect input. This may be implemented for all bosses, so that whenever a player fails to provide a timely input, the player's delay is treated as an incorrect input. Thus, in an embodiment, the player will automatically make an input within four seconds of the question because the failure to provide the correct input within the four seconds will be treated as an input representative of an incorrect answer. As can be appreciated, using time pressure to force the player to answer helps ensure the player remains alert and engaged in the video game. In addition, such a time constraint can also be useful for evaluating the player's mastery of the information. For instance, a player could generally calculate or discover the answer to a question if given enough time, but by requiring an answer within a certain period of time, the video game can gauge fairly effectively whether or not the player has committed the answer to long-term memory and respond accordingly by either allowing the player to move on or requiring further education of the fact that does not appear to be committed to the player's long-term memory. It should be noted that the player may be given a visual representation of the time remaining by providing a graphical element 830, such as a bar, that becomes smaller as the amount of time left to input an answer decreases. Numerous other graphical elements such as an hour glass or a pie chart and/or audio cues can also be used to inform the player of the amount of time remaining.

FIG. 6 illustrates an embodiment of the logic that may be used to control the player's interaction with a basket boss. The basket boss process starts at step 601. As soon as the basket boss is triggered, a fact is randomly selected in step 602. A check is made in 603 to see if the fact has been over-asked or has been passed-off (e.g., the player has shown mastery of the fact by answering a question associated with the fact correctly a predetermined number of times in a row). In an embodiment, a check could be made to see whether the same question had been asked more than twice in a row. In an alternative embodiment, a running total of the number of times that each fact has been asked could be maintained. Rejection of selected facts (or selection itself) could then be based on algorithms that help ensure each fact is used fairly evenly while allowing for randomness. In an embodiment, facts that were used twice more than the least used fact might be rejected until the least used fact was used an additional time. In an alternative embodiment, the probability of selecting a fact could be reduced the more it was selected instead of rejecting a fact so that due to probability, no one fact would be used excessively with respect to other facts. For example, if the probability of selecting a fact the next time was divided by some value, such as three, each time the fact was chosen more often than the least used fact, it is unlikely that any one fact would be used more than twice in a row. Numerous other methods of avoiding overuse of questions regarding a particular fact may also be used.

If the answer to the check in step 603 is yes, then a fact is again randomly selected and this process is repeated until an appropriate fact is selected. As can be appreciated, if a fact has been passed-off then it can be removed from the possible selection of randomly selected facts and then the check in step 603 will simply be whether or not the fact selected has been used more than the other remaining facts. However, it may also be advantageous to continue to employ this passed-off fact in the questioning in order to keep the player juggling a sufficient number of facts to demonstrate their mastery of the information. For example, if questions are being asked about three facts and then one of the facts is pulled out because it was passed-off, the player would be left to answer alternating questions about only the remaining two facts, which would probably not be a sufficiently challenging exercise to demonstrate or cultivate genuine mastery of the facts.

Once a fact is chosen to be used to ask a question, in step 604 a question is asked regarding the fact and the player's input is evaluated. If the answer is correct, the pass-off progress for the fact is increased in step 605 and a check is made in step 606 to see if all the facts have been successfully passed off. If they have, the player moves on to the next boss in step 607, which typically will result in the player moving to a new set of mini-bosses associated with another basket. However, if the player has progressed through all the basket bosses, then in step 607 the player would proceed to the final boss (associated with all the facts in the milestone 201). Thus, in the embodiment depicted in FIG. 3, after a player progressed through 4 basket bosses, the player would face a final boss. As can be appreciated, however, some other number of baskets may be used within a milestone.

Referring again to FIG. 6, if the player fails to input the correct answer in step 604, in step 608 the pass-off progress with respect to the entire basket is reset. While the pass-off progress could be reset to just a particular question, it is preferable to reset the entire basket because the player is not just demonstrating that they can answer a certain question, but that they know the answer so thoroughly that they can answer the question while simultaneously having to interrupt this knowledge by recalling answers to other questions. After the pass-off progress is reset, the player is told the answer in step 609. Then in step 610 the player is asked a question about the fact. If the player provides an incorrect input in response to the question in step 610, steps 608 and 609 are repeated. If the player gets the correct answer, then in step 611 the player is asked a question about a different fact. If the player provides an incorrect input in response to the question asked in step 611, then steps 608 and 609 are repeated with respect to the fact asked about in step 611. This process may be repeated but eventually the player will provide the correct input in both steps 610 and 611 and in step 612 the player will again be asked a question about the fact that was originally asked about in step 604. If the player provides the correct input in response to the question asked in step 612, step 602 will be repeated.

Thus, the depicted embodiment of how the basket boss interfaces with the player requires the player to answer each question correctly a certain number of times in a row. As the player will be randomly asked each question, the process prevents the player from developing an expectation of what the next question is going to be. Thus, the player is forced to respond to questions more spontaneously (i.e., questions are asked in an unpredictable manner), which typically requires having the facts stored more deeply into long term memory. Further time pressure may be applied if the player answers a question correctly a certain number of times in a row. Thus, by the time the basket bosses are defeated, the player has reached the point that they are recalling each fact quickly and automatically—without calculation or hesitation. It should be noted, however, that the testing and educating provided by the basket boss comes after the strategic interruptions provided by the mini-bosses, thus the basket bosses are used to reinforce and build on the prior learning. It should also be noted that the number of facts accumulated for each basket boss should be determined by the difficulty of the subject matter and the capabilities of the target players. In general it is preferable to include as many facts into a basket boss as possible, while not making it so hard to pass that players get overwhelmed or frustrated. For example, three facts per basket may be useful in a subject like multiplication children while 4 or 6 facts might be useful for a subject like addition or subtraction. Audiences with greater capabilities may also be suitable for additional facts in a basket, even if the additional facts are more complicated. Furthermore, multiple bosses may also be used simultaneously for simpler subjects or for individuals with greater learning capabilities.

In an embodiment where the basket relates to multiplication facts, the basket may include three facts and the player may be required to answer three questions about each fact correctly, at least 3 times with less than 4 seconds allowed per question. As soon as the player has demonstrated mastery of the basket of facts, the facts are essentially set aside and the player is allowed to move on to a completely new basket, or subset, of facts. If all of the baskets in the current milestone have already been completely mastered in this way, the player is allowed to meet the final boss (step 410 in FIG. 4).

The final boss tests the player for mastery of all the facts in the entire milestone 201. There should be a delay before the player faces the final boss that is long enough to ensure that any numbers the player has just barely learned will have faded from short-term memory. In an embodiment, this may be accomplished by requiring the player to progress through a video game using skills typical of entertainment based video games. It should be noted that typical skills used for entertainment video games may be intermixed throughout the video game so as to further provide motivation of the player, however it is anticipated that the engaging aspects of the education process will be sufficient in most cases, and to the extent possible all interactions should serve an educational purpose.

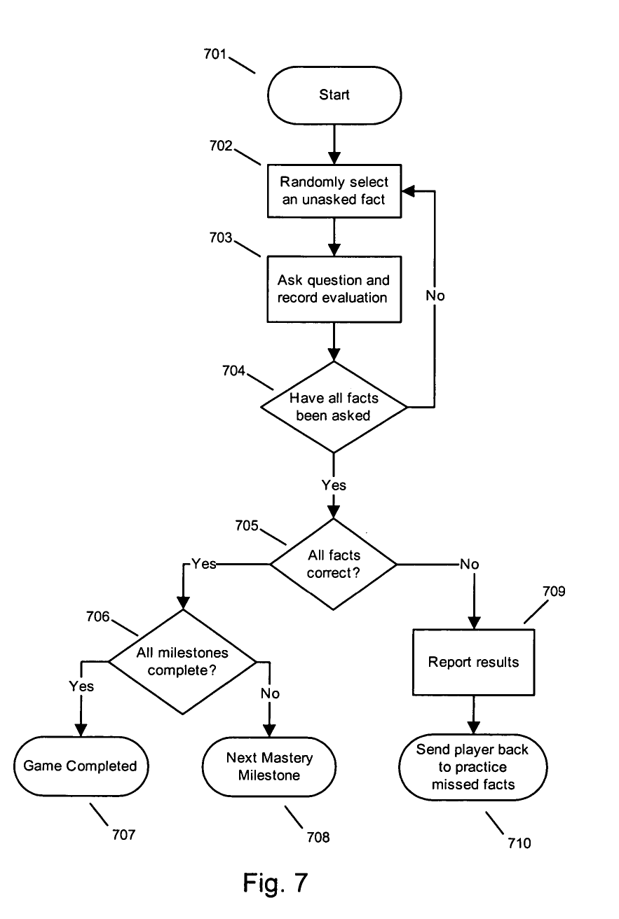

While the basket bosses and mini-bosses are used to teach the player the facts in the milestone 201, the final boss is used to evaluate the player's knowledge of the facts in the milestone. In an embodiment, the final boss can ask all the questions in the milestone in a random manner so as to test the player's knowledge. An embodiment of such a process is depicted in FIG. 7.

The method starts in step 701. In step 702, a question associated with a randomly selected fact is asked. The player's input is recorded and in step 704 a check is made to see if all questions associated with all the facts have been asked. If not, step 702 and 703 are repeated until one question has been asked about each fact in the milestone 201.

Then in step 705, the results of the evaluation are checked. If the player did not get all the answers correct, the results are reported in step 709 and the player is provided with one or more new baskets in which they can relearn the facts that were not known during the evaluation provided by the final boss in step 710.

However, if the player inputted a correct answer to each question, in step 706 a check is made to see if all the milestones have been completed. If they have not been completed, in step 708 the next milestone in initiated. If all the milestones have been completed, then in step 707 the game is completed.

It should be noted that the time allowed to answer each question should be set to the degree of recall demanded. For instance, allowing a player only two seconds to input an answer to each question could be rigorous, but could prove so demanding that players may get discouraged and quit. Therefore, a performance limit may be set at something such as three to four seconds. It should be noted that a fixed standard allows for more meaningful and comparable victories, but allowing for some flexibility will allow students with significantly different aptitudes and capabilities to achieve goals more appropriate to their respective abilities. Also, when determining the amount of time allowed to answer each question, the time required to enter the answer into the program should be included. A logical outcome of this planning would allow slightly more time for longer answers because it would take a bit more time to type in “144” than it would to simply enter “4”.

Regarding the possibility that the player does not input the correct answer to every question the first time, as noted, the incorrectly answered questions can be grouped together and used to form new baskets. It should be noted, however, that it is possible that the number of facts that require further practice will not divide perfectly into baskets, so that one basket may wind up with less than the desired number of facts. In this case, it's preferable that the player does not waste time fighting through repetitious or empty mini-bosses. For example, if the first basket only has 1 out of a normal 3 facts in it, it may be preferable to let the player start right at that basket's third mini-boss. However, as the effectiveness of the mini-bosses and basket bosses will be reduced if only one fact is included, additional facts that were known by the player can be added to round out the number of facts in the basket so as to teach the missed fact in a more effective manner through the use of strategic interruptions. Once the player has addressed all the missed facts, the player can be allowed to face the final boss again.

It should be noted that the delay between facing the final boss the first time and the second time is useful in ensuring that the player has placed all the facts into long term memory because facts that were only residing in short-term memory will have faded from the player's memory. Therefore, it is generally useful to set the difficulty of the final boss high enough so that the player will need to face it more than once to defeat it. One method of setting the difficulty is to reduce the time provided to answer each question. An alternate method would be to add more challenging gameplay as a distraction for the player, further ensuring that the player has comprehended the concepts being tested by the final boss.

After the player has “defeated” the final boss, the player will move into the next milestone of facts and preferably enter a new environment and/or receives some kind of valuable reward. These rewards are a useful source of gameplay motivation and can help keep the player motivated to continue passing off milestones.

Once all the final bosses have been defeated, the player may then be faced with a super boss that goes through every fact in the dataset 101. If the player managed to answer every single question correctly, the game would be complete and the player could be treated to some sort of rewarding cut scene or additional gameplay. However, if the player did not input the correct answer to all the questions, the facts associated with missed questions could be grouped into new milestones 201 and baskets 301 so as to allow the player to go back and continue to work on facts that were not deeply ingrained in the player's long-term memory. As before, the super boss could be repeated once the player had progressed through each of the new milestones 201. However, given the large number of facts, care should be exercised to ensure the super boss was engaging rather than simply difficult.

In an embodiment, the time limit imposed by the final boss (or the super boss, if used) can be determined based on the mastery requirements of the game. However, lower-level bosses, such as the mini-bosses and the basket-bosses may be configured so as to adjust to the learning speed of the individual player. In an embodiment, this can be accomplished by adjusting the allowable response time based on whether the player provides an input that is correct or incorrect. In an embodiment, an input that provides an incorrect answer can increase the current allotted time to answer a question by multiplying the current time by a variable such as 1.2, 1.3, 1.4, 1.5 or some other value. Each correct answer can be used to reduce the time to answer the next question by dividing the current time by a smaller variable such as 1.05, 1.1. 1.15 or 1.2 until the time reaches the preferred minimum time. As can be appreciated, some value other than one of the values disclosed may also be used. Other methods as could also be used to adapt the gameplay and the questions to the individual player's capabilities. Preferably, however, the reaction to correctly answered questions should be slower than the reaction to incorrectly answered questions. Otherwise the time period may osculate in an unstable manner and may jump back and forth between being too slow and too fast. Using different values (with a greater increase in time for an incorrect answer than a corresponding decrease because of a correct answer) should also tend to allow the time period to approach equilibrium more smoothly.

As noted above, incorporating educational questions directly into virtual entities that the player can battle has the effect of making the gameplay more engaging. One method of battling may be with the use of mental ammunition as a result of correctly inputted answers. As can be appreciated, the concept of using mental ammunition to directly battle educational concepts embodied in interactive entities allows an educational game to retain all the fast-paced, intense entertainment of advanced video games while simultaneously incorporating rigorous, effective educational practice.

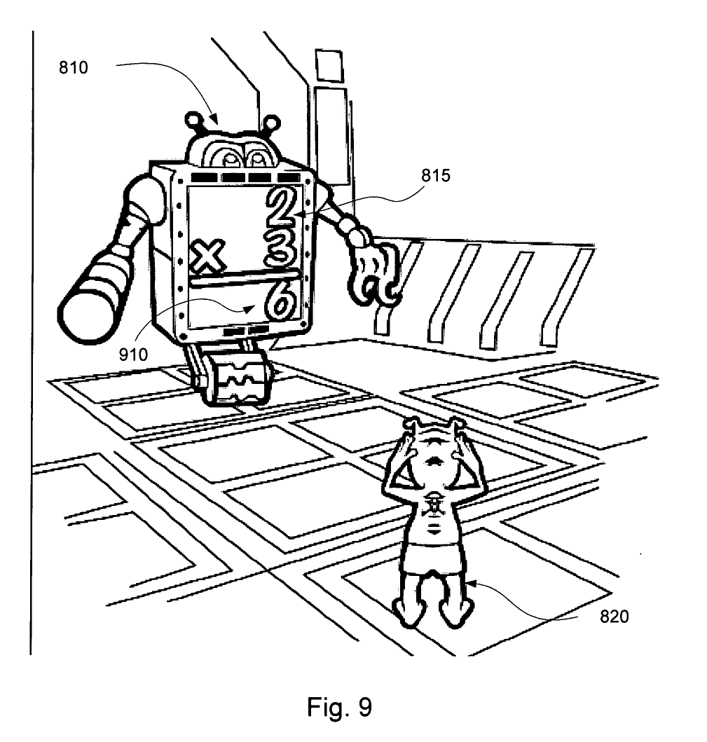

To effectively provide this type of interaction, it is useful that the education concept be directly integrated into the virtual entity the player is facing, preferable allowing room for both the question and the answer. For example, looking at FIG. 8, a virtual entity 810, which is represented as an ogre, is depicted with a question 815 “11×2” that is prominently displayed on the virtual entity 810. Thus, the virtual entity 810 is an embodiment of a boss. To damage the virtual entity 810, the player must input the correct answer. FIG. 9 illustrates an example where the player inputted a correct answer 910. The player may use “mental ammunition” by inputting a number and that input may cause the answer 910 to appear on the virtual entity 810. Inputs that are correct may cause the virtual entity 810 to simulate being damaged while incorrect answers may allow the virtual entity 810 to attack the player's avatar 820. For example, the virtual entity 810 in FIG. 8 could be knocked back by a correct answer 910 or shoot the player's avatar 820 with green goo that emanates from a representation of a club in response to an incorrect answer. In an embodiment, the mental ammunition may be simulated as a bolt or projection emanating from the avatar 820. Alternatively, the avatar 820 could simulate the attack of the mental ammunition with sound or gestures. And if the input is automatically processed once the player enters the appropriate number of digit without the need for the player to press an “enter” or “accept” key, the gameplay is improved.

Other forms of interaction between the avatar 820 and the virtual entity 810 may include a projectile fired by a virtual entity 810 that requires the correct answer in order to block it from hitting the player's avatar 820. The interaction of the avatar 820 with the virtual entity 810 could also be cooperative, with the virtual entity 810 being endangered in such a way that the player can save it with their correct answers. Alternatively, the virtual entity 810 could speak the question while requiring the player to type in the correct input, which would force the player to interact with both audible and visual medium and thus further enforce the efficiency of the learning process. The player could also speak the answer, which would then be inputted using the above noted speech recognition engine.

While the interaction between the player and the virtual entity may be combative, other interactions are also contemplated. In an alternative, the education concepts may be transmogrified into virtual entities that may be interacted with in educationally meaningful ways. Turning to FIG. 10, an embodiment of an education concept transmogrifying into a virtual entity is depicted. As illustrated, question 815 is displayed on a set of doors and to open the doors the player must input the correct answer, which in this case is “12.” However, rather than require the player to type in the number “12,” the answer is depicted as a set of dots on the wall, which are a graphical depiction 1005 of the fact that “3×4=12.” To further aid the player's comprehension, the graphical depiction 1005 of the fact can transform into virtual entities 810 that can then be further interacted with. As depicted, the graphical depiction 1005 transforms into an intermediate shape 1010, a sphere in FIG. 11, and then transforms into a virtual entity 810, which in FIG. 11 is a depiction of a snail. Each of the virtual entities 810 (e.g., snails) can be caught and when caught will be worth four points.

As the player collects each virtual entity and throws them back onto the wall they came from, they're able to build the answer in a highly engaging, yet educationally meaningful way. This lets the player build the answer to “3×4” as the first creature they collect gives them “4”, then “8”, and finally “12.”

This idea is similar to embodying educational concepts directly into virtual entities—as discussed earlier, but may be used when an educational concept is simple enough that its meaning can be clearly transferred to a representative entity. As a result, the fact does not need to be literally displayed as a part of the virtual entity, either visually or with audio, although such inclusion is recommend where practicable. For instance, if a graphical depiction of three was illustrated by a group of three dots and if the three dots transformed into a snail shaped virtual entity, the virtual entity could have 3 dots on it.

To implement this method, it is helpful to allow the player to observe the transmogrification from the graphical depiction 1005 of the fact being taught to the representative virtual entity 810 such that the player can tell that the one has turned into the other. For example, in FIG. 10, the graphical depiction 1005, which is a card with four dots, shrinks and transforms into an intermediate shape 1010 (a sphere) before transmogrify into a virtual entity 810 shaped as a snail. As can be appreciated, other virtual entity shapes may also be used, limited primarily by the game developer's imagination.

Next the player may control an avatar 820 on screen (not shown for purposes of clarity) so that the avatar 820 moves around collecting each virtual entity 810. Each time a virtual entity 810 is collected, the value of the virtual entity 810 is added to the value of any virtual entities previously collected. This value may be displayed visually. It may also cause the generation of audible feedback such as the increase in the number value played back in sound. In this manner, the player is able to build or create the answer to “3×4.”

To further enforce the learning process, the player can then be required to throw the creatures back at the door, where they transmogrify back into the original educational concepts. As they throw the creature back at the door, they once again build the answer to the problem as they are added once again with both visuals and sound: “4”, “8”, and finally, “12”.

This method is not limited to mathematical concepts. For instance, words, dates, or even more complex concepts could be transmogrify into entities which might then be captured or manipulated in such a way as to develop a greater mastery of the information. With more complex concepts, it is recommended that the resulting virtual entity inherit a label of some kind to help the player more closely associate the fact with the virtual entity.

As noted above, the video game interface can be an important aspect of helping the player enjoy the entertainment aspects of the video game. A simple to use method of inputting answers is therefore beneficial because it avoids unduly interfering with the engaging aspects of the video game. In an embodiment, players may enter responses by typing answers on a keyboard without having to hit an “enter” or “accept” key. As can be appreciated, this can allow for smoother, faster—and thereby more engaging—gameplay. If used in junction with a console where the player uses a controller, the numbers could also be inputted with the controller. While numerous methods for doing so are possible, one method might be to rotate a joystick with one hand to simulate turning a number wheel and pressing a button with the other hand when the correct number was shown.

In an embodiment, the process of answer input may be accomplished by anticipating the player's answers. In the case of math facts, the player's input is expected to have the correct number of digits. Therefore, if the answer is a single digit, such as 8, the game automatically processes the input after a single digit is entered by the player. If the answer requires two digits, such as 32, the game automatically proceeds upon the input of the second digit by the player. Furthermore, if the answer requires 3 digits, the game will process the input after the third digit is inputted. Thus, the input is automatically processed once the corresponding number of digits is entered.

If more than one digit is necessary to answer the question correctly, a player may use a backspace to clear an initial entry if the player realizes a mistake is being made. But as soon as the last key is entered, the answer is automatically processed and therefore may be considered final. It should be noted that additional time may be provided if the backspace key is used, however, it may be beneficial to limit the amount of additional time that can be gained by using the backspace key so as to prevent users from being able to extend the time period as long as they would like.

This method may be used with answers to facts unrelated to mathematics. For instance, if a player is attempting to learn words, the game may be programmed to anticipate whatever word the player could or should be typing and make an educated assumption of when the player is finished typing (such as when the number of characters provided by the input equals the number of characters in the correct answer. While generic input periods may be used when the player inputs digits, it is more difficult to type than to simply hit the correct numbers. Therefore, to aid in determining the amount of time that should be allotted to the player when text input is required, the player may first be asked to type one or more sentences so that the player's typing rate can be estimated.

The present invention has been described in terms of preferred and exemplary embodiments thereof. Numerous other embodiments, modifications and variations within the scope and spirit of the appended claims will occur to persons of ordinary skill in the art from a review of this disclosure.

We claim:

1. A computerized method of teaching facts in a dataset to a player through player interaction with a simulated virtual environment graphically depicted on a display device, wherein the facts in the dataset are divided into sets of facts and each set is divided into subsets of facts, the method comprising:
(a) selecting a first subset of facts from a first set of facts;
(b) providing a first fact and a second fact from the first subset; and
(c) after providing the second fact, displaying a first and second question subsequently in the simulated virtual environment, wherein the first and second questions are respectively associated with the first and second facts and the first and second questions are incorporated into a first virtual entity graphically depicted in the virtual environment, wherein each question displayed requires an input associated with the respective associated fact before proceeding to a subsequent question, whereby the answering of each question interrupts the player's short-term memory of a previously learned fact.

2. The method of claim 1, wherein the providing in (b) further comprises providing a third fact and the displaying of questions in (c) includes displaying a third question associated with the third fact after the display of the second question, wherein the third question requires an input associated with the third fact before proceeding to a subsequent question.

3. The method of claim 2, further comprising:
(d) displaying a first plurality of questions associated with each fact in the first subset randomly, wherein each of the first plurality of questions is incorporated into a second virtual entity and each question displayed requires an input corresponding to the associated fact before proceeding to a subsequent question.

4. The method of claim 3, further comprising:
(e) repeating (a) through (d) for each subset of facts in the first set of facts.

5. The method of claim 4, further comprising:
(f) providing questions associated with all the facts in the first set, wherein each question requires an input to proceed to the next question;
(g) determining whether the inputs associated with the questions provided in (f) were correct;
(h) grouping the facts associated with incorrect inputs into one or more additional subsets of facts; and
(i) repeating (a) through (d) on each of the one or more additional subsets of facts.

6. The method of claim 4, further comprising:
(f) repeating (a) through (e) for each set of facts in the dataset.

7. The method of claim 1, further comprising:
(d) in response to an input that correctly corresponds to the fact associated with question being displayed, simulating the virtual entity as being harmed.

8. The method of claim 1, wherein the displaying of the facts in (b) comprises:
(i) displaying each fact;
(ii) asking a question associated with each fact, the question requiring an input by the user; and
(iii) verifying that the input is correct before proceeding to the next fact.

9. The method of claim 1, further comprising:
(d) receiving the input associated with each question from a keyboard, wherein the input is automatically entered once the player presses an expected number of keys.

10. A computer readable medium comprising computer readable instructions for performing the steps of:
(a) selecting a first set of facts to be used to test a player's knowledge;
(b) displaying a graphical depiction of a first fact from the first set of facts in a virtual simulated environment;
(c) transmogrifying the graphical depiction of the first fact into a first set of virtual entities;
(d) determining that the player has interacted with the first set of virtual entities; and
(e) in response to the player's interaction with the virtual entities; transmogrifying the first set of virtual entities back into the graphical depiction of the first fact.

11. The method of claim 10, wherein the determining in (d) includes determining that the player has collected the virtual entities.

12. The method of claim 10, wherein the transmogrifying in (c) comprises:
(i) transforming the graphical depiction into an intermediate shape; and
(ii) transforming the intermediate shape into a virtual entity.

13. The method of claim 10, further comprising:
(f) displaying a boss virtual entity in the simulated virtual environment, the boss virtual entity incorporating a question associated the first fact; and
(g) receiving an input associated with player's response to the question incorporated into the boss virtual entity.

14. The method of claim 13, wherein the interacting in (f) further requires knowledge of a second fact, wherein the second fact was previously transformed into a second set of virtual entities that required the player to interact with the second set of virtual entities.

15. The method of claim 10, further comprising:
(f) repeating (b) through (e) for a second fact that was selected from the set of facts; and
(g) requiring an interacting with a boss virtual entity after the player interacts with the virtual entities, wherein the interaction with the boss virtual entity requires knowledge of the first fact and the second fact.

16. The method of claim 15, wherein the interaction in (g) comprises:
(i) displaying a question on the boss virtual entity; and
(ii) accepting an input from the keyboard, wherein the input is automatically entered once the player presses the expected number of keys.

17. The method of claim 16, wherein the displaying of the question in (i) comprises:
(1) selecting a question to be displayed that strategically interrupts the player's short term memory of one of the first and second facts.

18. A computer implemented method of teaching a dataset of facts to an individual, comprising:
(a) providing a first fact from the dataset to the individual, the first fact being visually transmogrified to aid comprehension of the first fact;
(b) providing a second fact from dataset to the individual, the second fact being visually transmogrified to aid comprehension of the second fact;
(c) after providing the second fact, displaying a virtual entity in a simulated virtual environment, the virtual entity incorporating a first question about the first fact;
(d) receiving a first input corresponding to the first fact; and
(e) displaying a second question on the virtual entity associated with the second fact.

19. The computer method of claim 18, wherein the receiving in (d) comprises:
(i) receiving at least one key press from a keyboard; and
(ii) processing the at least one key press automatically when the number of at least one key press equals the number of key presses anticipated.

20. The computer method claim 18, further comprising:
(f) receiving a second input corresponding to the second fact; and
(g) providing an indication that the virtual entity is defeated.
